(19) United States
(12) Patent Application Publication
(10) Pub. No.: US 2022/0404845 A1
(43) Pub. Date: Dec. 22, 2022

(54) PRESSURE STABILIZER

(71) Applicants: UNIVERSIDADE DE COIMBRA, COIMBRA (PT); UNIVERSIDADE DO ALGARVE, FARO (PT)

(72) Inventors: João Luís MENDES PEDROSO DE LIMA, COIMBRA (PT); Jorge Manuel GUIEIRO PEREIRA ISIDORO, FARO (PT)

(21) Appl. No.: 17/774,131

(22) PCT Filed: Nov. 4, 2020
(86) PCT No.: PCT/PT2020/050041

§ 371 Date: May 3, 2022

(30) Foreign Application Priority Data
Nov. 4, 2019 (PT) 115890

(51) Int. Cl. G05D 16/04; F16K 17/18

(52) U.S. Cl. CPC G05D 16/0402; F16K 17/18

(57) ABSTRACT

The present invention relates to a pressure stabilizer (14) comprising a constant pressure chamber (10) to which 3 pipes are attached, namely an outlet pipe (13), located downstream of the pressure stabilizer (14), an inlet pipe (11) and a return pipe (12), both placed upstream of the pressure stabilizer (14). The pressure stabilizer (14) prevents hydraulic shocks, which can potentially damage hydraulic installations. The devices described in the state of the art do not allow to stabilize efficiently spiky pressure fluctuations by means of simple hydraulic systems. The present invention by means of the combined operation of a pressure reducing valve (2) and a relief valve (3), will eliminate the pressure peaks at the inlet of hydraulic installations.

### TECHNICAL FIELD

The present invention relates to a liquid pressure stabilizer and a liquid pressure stabilization process, which can be used in pressurized liquid systems.

Pressurized liquid systems have a very wide range of uses, for example, in systems that require precise control of liquid pressure, such as precision industrial dosers.

### BACKGROUND ART

Pressurized systems are universally used in several areas, as is the case, among others, with precision industrial dosing systems, such as those found in liquid product filling lines in containers, where the products are relevant, for example, for the food, pharmaceutical, cosmetic and chemical industries. Other areas that can be used by the pressure stabilizer of the present invention are the systems for applying coating compounds, such as industrial spray guns, as is the case among other spray guns used in the industry/automotive sector.

These systems are usually fed from a pumping system, or directly from a more or less complex pressurized network.

This mean these systems are subject to pressure fluctuations, of lesser magnitude when the supply is made from a pumping system (e.g., due to variations in the supply of electricity), but more pronounced when it is made from an hydraulic network (e.g., due to fluctuations in consumption and injection of liquid at several points of those networks over time, namely throughout the day).

However, more specific applications, as is the case among other industrial environments, required to reduce pressure fluctuations at the outlet of pressurized systems as much as possible, regardless of whether they are pressurized or at atmospheric pressure.

There are solutions in the state-of-the-art that allow pressure to stabilize, usually by reducing pressure (e.g., pressure reducing valves or using pressurized tanks). However, although these solutions ensure the reduction of pressure fluctuations over time downstream of an installation, they do not guarantee the absence of instantaneous pressure peaks that occur when opening and closing hydraulic systems, which are very relevant when operating movements are very fast (e.g., solenoid valve operation). This type of movement causes hydraulic shocks, which can potentially damage hydraulic installations.

Additionally, pressure fluctuations can cause significant variations in filling operations for liquid products in filling lines, for example in the food, pharmaceutical, cosmetic and chemical industries. The state-of-the-art illustrates the need for developing efficient pressure stabilizers, which provide an increase in the control of the quantity of a product added to a packaging container, which allows a substantial decrease in the standard deviation of the quantity of product added to each package, i.e. reducing the non-conformities of the filling line. In the case of devices for applying coating compounds, such as, paints, the state-of-the-art illustrates the need for developing efficient pressure stabilizers that cause the standardization of the amount of coating applied on a certain surface.

The pressure stabilizer described and claimed in the present invention does not require any external energy for its operation, making use only of the energy of the liquid or pressurized liquid in motion. On the other hand, the pressure stabilizer does not generate energy, i.e. the constant and stabilized pressure of the pressurized liquid at the outlet of the pressure stabilizer is necessarily less than, or equal, to the pressure of the pressurized liquid at the inlet of the pressure stabilizer.

These fluid pressure peaks are particularly evident in hydraulic systems where flexible pipes are used, which undergo deformation when subjected to the pressure caused by the respective fluids. These flexible pipes of said hydraulic systems, when absorbing or releasing energy as a consequence of their deformation, can cause rapid pressure fluctuations in the fluid.

When an inlet pipe is flexible, the pipe material can expand, accumulating potential energy, which can eventually be released in the form of pressure, causing pressure peaks in the hydraulic systems.

These problems associated with the deformation of flexible pipes are known (Longmore, D. and Schlesinger, A. (1991). “Transmission of Vibration and Pressure Fluctuations Through Hydraulic Hoses”. Proceedings of the Institution of Mechanical Engineers, Part I: Journal of Systems and Control Engineering, 205 (2), 97-104).

Currently, these problems still occur, with implications for different applications (Paltrinieri, F., Milani, M., Montorsi, L., and Terzi, S. (2018). “Modelling and Testing an Innovative Combined Hydraulic Valve for High-Pressure Washing”. Global Fluid Power Society PhD Symposium (GFPS), Samara, Russia, 2018, pp. 1-11).

The pressure stabilizer, described and claimed in the present invention, allows to eliminate the occurrence of this type of pressure fluctuations/spikes/peaks, leading to a stabilized pressure. Regardless of the pressure of the inlet liquid, the pressure of the outlet liquid, downstream of the pressure stabilizer, is free from fluctuations and thus stabilized.

The pressurized systems that supply the inlet liquid to the hydraulic systems can present very pronounced pressure fluctuations, depending on the design of the networks, fluctuations in consumption throughout the network and in time, and the admission of liquids at various points of those same networks that can also change over time.

These pressure fluctuations can be harmful, damaging these hydraulic systems and/or equipment or reducing their effectiveness, for example in liquid spray systems, in which the pressure of liquid application must be stabilized with substantially reduced fluctuations, to ensure homogeneity of the volume of liquid applied, e.g. in filling lines in containers of liquid products or systems for applying coating compounds, such as paints.

### SUMMARY OF INVENTION

The present invention relates to a pressure stabilizer for pressurized systems that allows to maintain constant pressure at atmospheric outlets or pressurized outlets.

The pressure stabilizer described and claimed in the present invention comprises a set of valves, filters, piping and optional accessories, installed upstream of the atmospheric or pressurized outlet, as is the case among others, of a pipeline, a network, or a nozzle.

The present invention allows that, regardless of the pressure upstream of the pressure stabilizer, a stabilized pressure can be achieved downstream of the pressure stabilizer, even in situations of abrupt pressure fluctuations at several points in the system where it is installed.

It is a pressure stabilizer with a large number of possible uses.

The pressure stabilizer was developed with the objective of reducing the temporal fluctuation of pressure in systems with pressurized liquids, with pressurized or atmospheric outlets.

The pressure stabilizer described and claimed in the present patent application is intended to constitute a new device at a low cost, which will allow stabilizing the outlet pressure of liquids in pressurized hydraulic systems.

To fulfil the need of stabilizing pressure at the outlet of pressurized systems, the present pressure stabilizer was designed and developed based on the following guidelines:
i. low-cost;
ii. simplicity; and
iii. adaptability.

Thus, the pressure stabilizer described and claimed in the present invention was developed with inexpensive, but very reliable components, ensuring a solid, reliable and easy to use set, which can be easily installed in systems with pressurized or atmospheric outlets, with or without electrical power supply.

The effectiveness and efficiency of the pressure stabilizer were verified through a set of tests specifically designed for this purpose.

These tests were carried out at the Laboratory of Hydraulics, Water Resources and Environment, of the Department of Civil Engineering, Faculty of Sciences and Technology, University of Coimbra, in Portugal.

The results of these tests show the capability of this equipment to stabilize the outlet pressure of a pressurized hydraulic system, regardless of whether this outlet is pressurized or at atmospheric pressure, and regardless of pressure fluctuations at the inlet of the system.

In the preferred modalities of the present invention, the pressure stabilizer described and claimed in the present invention does not require any external energy supply to function, making use only of the energy of the liquid in motion.

However, it is encompassed within the scope of the present invention that some components of the pressure stabilizer may be electrified to facilitate its operation (e.g., shut-off solenoid valve operation).

The pressure stabilizer described and claimed in the present invention has the following advantages:
allows to stabilize the pressure in systems where it is applied;
the pressurized systems where the pressure stabilizer is applied may have outlets at atmospheric pressure or pressurized, i.e. these systems may have outlets at atmospheric pressure, as is the case with nozzles, sprinklers or nebulizers, or outlets to another pressurized system such as water distribution networks or outlets to a pressurized liquid reservoir;
can be used with different liquids, such as water, olive oil, mineral oil, wine, milk, juices and paints, pharmaceutical compositions (for example elixirs and syrups), cosmetic compositions (for example liquid soaps and products for the hair hygiene), food products (for example sauces), if these liquids do not suffer boiling or freezing;
can be installed in pipes, pipelines, networks and at the inlet or outlet of atmospheric or pressurized reservoirs; allows the monitoring of the stabilized pressure at the outlet using a pressure gauge;
allows the removal/extraction of air in the constant pressure chamber through the ventilation tube, in which an air release valve can be installed;
allows the removal of particles accumulated in the constant pressure chamber by means of a shut-off valve installed in the bottom drainage pipe;
it is compatible with the use of accessories operated manually, electrically or pneumatically, namely valves; and
does not need an external source of energy, e.g. electrical, for its operation.

### BRIEF DESCRIPTION OF DRAWINGS

To promote an understanding of the principles in accordance with the modalities of the present invention, reference will be made to the modalities illustrated in the figures and the language used to describe them. In any case, there is no intention to limit the scope of the present invention to the content of the figures.

Any subsequent changes or modifications to the inventive features illustrated herein and any additional applications of the illustrated principles and modalities of the invention, which would normally occur to a person skilled in the art having possession of this description, are considered within the scope of the claimed invention.

FIG. 1 A pressure stabilizer (14); and

FIG. 2 One of the pressure stabilizer (14) embodiments.

### DESCRIPTION OF EMBODIMENTS

The following description aims to describe in detail the equipment that makes up the present invention, namely a pressure stabilizer (14), and its operation.

Firstly, the present invention relates to a pressure stabilizer (14) for liquids comprising:
a constant pressure chamber (10);
an outlet pipe (13) which is attached to the constant pressure chamber (10) by means of a downstream fitting socket (16), in which an outlet shut-off valve (4) is connected to the outlet pipe (13);
an inlet pipe (11) which is attached to the constant pressure chamber (10) by means of an upstream fitting socket (17), wherein a pressure reducing valve (2) is connected to the inlet pipe (11); and
a return pipe (12) which is attached to the constant pressure chamber (10) by means of a return fitting socket (18), wherein a relief valve (3) is connected to the return pipe (12).

Secondly, the present invention relates to a process of stabilizing the pressure of a liquid, which uses the pressure stabilizer (14) of the present invention and comprises the following steps:
i. closing the outlet shut-off valve (4);
ii. inflow of a pressurized liquid (15) through the inlet pipe (11) with a reduction of the liquid's pressure through the operation of the pressure reducing valve (2);
iii. filling the constant pressure chamber (10) with liquid until the relief valve (3) starts operating;
iv. opening the outlet shut-off valve (4);
v. adjusting the pressure inside the constant pressure chamber (10) through the operation of the pressure reducing valve (2), connected to the inlet pipe (11), and the relief valve (3), connected to the return pipe (12); and
vi. outflow of the liquid with stabilized pressure through the outlet pipe (13).

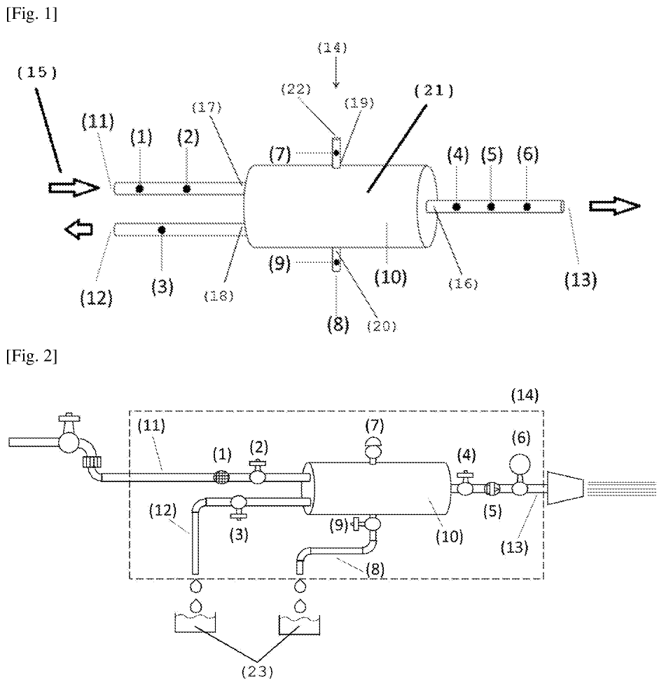

This description, as well as FIGS. 1 and 2 that accompany it, allow the understanding and use of the present invention by a person skilled in the art in pressurized systems for supplying a pressurized liquid (15), also allowing the implementation of several modifications or adaptations of the invention with the aim of using it for specific purposes.

To facilitate the detailed description of the present invention, it is always indicated that the liquid used in the pressure stabilizer (14) is a pressurized liquid (15), as are the non-limiting examples of: water; oil (e.g., olive oil, mineral oil); wine; milk; juices; coating compounds (e.g., paints and varnishes); pharmaceutical compositions (e.g., syrups and elixirs); cosmetic compositions (e.g., liquid soaps, perfumes and hair cleaning products); food products (e.g., sauces); solvents; fuels; and chemical reagents.

As shown in FIG. 1, the pressure stabilizer (14) comprises:
a set of pipes, which can be rigid or flexible, according to the specific use of the pressure stabilizer (14);
valves; and
other accessories.

From the constant pressure chamber (10) two pipes come out, respectively located upstream and downstream, namely, a return pipe (12) and an outlet pipe (13).

The pressure stabilizer (14) comprises an inlet pipe (11), upstream of the constant pressure chamber (10), which can be rigid or flexible. A pressure reducing valve (2) is connected to the inlet pipe (11).

In one of the preferred embodiments of the present invention, the pressurized liquid (15) flows through a filter (1), which is attached to the inlet pipe (11), supplying the constant pressure chamber (10). The filter (1) can be installed upstream of the pressure reducing valve (2), in series with it.

The constant pressure chamber (10) is made of a rigid material. The return pipe (12) and outlet pipe (13) can be rigid or flexible, preferably rigid.

An outlet shut-off valve (4) and a check valve (5) are connected to the outlet pipe (13). A relief valve (3) is connected to the return pipe (12).

In the preferred embodiments of the present invention, the material of the inlet pipe (11), the return pipe (12), the outlet pipe (13) and the constant pressure chamber (10) have rigid characteristics, to maximize results in the operation of the pressure stabilizer (14), so that there are no variations in its volume due to the elasticity of its components, which would decrease its effectiveness.

Consequently, in these preferred embodiments it is possible to guarantee the pressure without significant variation of the liquid with a set pressure (21) inside the constant pressure chamber (10) and downstream of the outlet pipe (13).

The constant pressure chamber (10), the inlet pipe (11), the return pipe (12) and the outlet pipe (13), can preferably be manufactured from the materials selected from: cast iron; steel; PVC; polyethylene, for example HDPE; polypropylene; and polyurethane.

The relief valve (3), according to one of the embodiments of the present invention, has the functionality of releasing liquid in the event of an excess pressure (e.g., fast shut-off of the outlet shut-off valve (4)).

The outlet shut-off valve (4), according to one of the modalities of the present invention, can be a shut-off valve or a valve for controlling the flow and pressure of the liquid with set pressure (21).

The outlet shut-off valve (4) has the functionality to allow the opening and cutting the flow downstream of it. Shut-off valves described in the art, such as ball valves, butterfly valves, gate valves, spherical or cylindrical segment valves, needle valves or electrically operated valves, such as solenoid valves, are suitable for use in the field of the present invention.

When the outlet shut-off valve (4) is of the control type, flow control valves, such as the globe or the gate valve, can be used.

In the even more preferred embodiments of the present invention, the outlet shut-off valve (4) employed is of the quick-closing type, such as solenoid valves. This type of valves may suffer from sediments in the liquid, causing a certain dripping after closing, which can be avoided by using the filter (1).

The pressure stabilizer (14) eliminates this dripping, by the operation of the pressure reducing valve (2) and the relief valve (3).

The pressure reducing valve (2) has the function of limiting the pressure of the pressurized liquid (15) in the downstream system, namely to prevent the existence/occurrence of pressure peaks with origin upstream of the pressure stabilizer (14).

To stabilize the pressure in the constant pressure chamber (10), it is necessary to set the opening pressure of the pressure reducing valve (2) and the relief valve (3).

In the preferred embodiments of the present invention, in the constant pressure chamber (10) there are two connections:
one at the top for a ventilation tube (22), and another,
at the bottom for a discharge through the bottom drain pipe (8) which can be operated by a bottom drainage shut-off valve (9).

In the preferred embodiments of the present invention, in the outlet pipe (13), located downstream of the constant pressure chamber (10), there are 3 components placed in series, namely an outlet shut-off valve (4) and downstream of this, there is a check valve (5) and finally, downstream of the latter, there is a socket for fixing the pressure gauge (6).

A pressure gauge, in one of the preferred embodiments of the present invention, is used to monitor the stabilized pressure of the liquid, when the application requires monitoring of the liquid with a set pressure (21). Alternatively, the socket for fixing the pressure gauge (6) and the pressure gauge can be installed between the constant pressure chamber (10) and the outlet shut-off valve (4), when it is relevant to monitor the pressure of the liquid with a set pressure (21).

The check valve (5) has the function of preventing backflow, i.e. that the liquid with a set pressure (21) may flow from downstream to upstream of the check valve (5). Check valves known in the art, such as piston valves, swing (or clapper) valves, spring (or disc) valves, ball valves, are suitable for use within the scope of the present invention.

The check valve (5) will prevent, in the event of a pressure peak of the liquid with a set pressure (21) downstream of the check valve (5), that this pressure peak does not propagate upstream of the check valve (5), i.e. for the pressure stabilizer (14), more specifically for all the components that constitute the pressure stabilizer (14) and which are located upstream of the check valve (5).

In the preferred embodiments of the present invention, downstream of the check valve (5) there is a socket for fixing the pressure gauge (6), this pressure measuring equipment, depending on the mode of implementing the present invention, can be, e.g., a pressure gauge or a pressure sensor, which are suitable for use within the scope of the present invention.

The constant pressure chamber (10) can be of any dimension, larger than the minimum volume that allows the installation of the accessories that constitute the pressure stabilizer (14), specifically, the filter (1), the pressure reducing valve (2), the relief valve (3), the outlet shut-off valve (4), the check valve (5), the socket for fixing the pressure gauge (6), the air relief valve (7), the bottom drain pipe(8) and the bottom drainage shut-off valve (9).

A person skilled in the art will be able to design the pressure stabilizer according to the desired flow rates and the diameters of the pipes.

### MODE FOR THE INVENTION

With the pressure stabilizer (14) it is intended to transform the non-stabilized pressure of a pressurized liquid (15) upstream of the pressure stabilizer (14) into a liquid with a set pressure (21) inside the constant pressure chamber (10).

The pressurized liquid (15), from a pressurized network or from a reservoir, after having its pressure stabilized to a liquid with a set pressure (21), can be used with an outlet at atmospheric pressure (e.g., orifice, nozzle, sprinkler) or pressurized (e.g., pipe, mains, network, reservoir).

The method of operation of the pressure stabilizer (14) comprises the initial closing of the outlet shut-off valve (4) and the previous setting of the pressure reducing valve (2) and the relief valve (3), according to the pressure desired for the liquid with set pressure (21).

Then, a valve located upstream of the pressure reducing valve (2), not shown in FIG. 1 but exemplified by the tap in FIG. 2, is opened, which discharges the pressurized liquid (15). The pressure reducing valve (2) reduces the pressure of the pressurized liquid (15) to the desired level.

During the filling with the liquid, the constant pressure chamber (10), will be completely filled, because the outlet shut-off valve (4) is closed, as so the liquid will flow through the return pipe (12), where the relief valve (3) relieves any pressure peaks upstream of the pressure stabilizer (14), making it possible to have a liquid with a set pressure (21) inside the constant pressure chamber (10).

Then, the outlet shut-off valve (4) is opened, releasing the liquid with set pressure (21), where the relief valve (3), installed in the return pipe (12), eliminates or attenuates any pressure peaks resulting from opening or closing of the outlet shut-off valve (4), mainly the peaks related to rapid opening and/or closing valve operations.

The set pressure of the pressure reducing valve (2) should be established at a value lower than the lowest pressure expected in the constant pressure chamber (10), considering the expected or observed range of pressure peaks in the constant pressure chamber (10).

In the even more preferred embodiments of the present invention, the set pressures of the pressure reducing valve (2) and the relief valve (3) are adjusted ensuring that these set pressures are similar, to minimize the loss of liquid through the return pipe (12). However, it will be known by a person skilled in the art that the pressure reducing valve (2) and the relief valve (3) can be set at substantially different pressures in case the applications justify larger volumes of liquid released by the return pipe (12).

It will be known by a person skilled in the art that the pressure of the liquid downstream of the outlet shut-off valve (4) may be atmospheric or slightly lower than the pressure of the liquid with adjusted pressure (21), due to headlosses caused, e.g., by the flow of the liquid through the outlet shut-off valve (4) and the outlet pipe (13).

The pressurized liquid (15) with non-stabilized pressure inflowing through the rigid inlet pipe (11), as shown in FIG. 1 and according to one of the embodiments of the present invention, initially flows through the filter (1) which removes particles and other impurities that may cause malfunction to sensitive valves, namely the pressure reducing valve (2), the outlet shut-off valve (4) and the relief valve (3), especially if they are operated electrically, according to a preferred embodiment of the present invention.

The pressure reducing valve (2), set to a pressure lower than the lowest expected pressure to occur in the supply of pressurized liquid (15) through the inlet pipe (11), ensures that the pressure fluctuations upstream of the pressure stabilizer (14), specifically upstream of the inlet pipe (11) are not propagated downstream, thus maintaining the pressure of the liquid with a set pressure (21) inside the constant pressure chamber (10) and the pressure of the liquid in the outlet pipe (13), independently of the pressure fluctuations of the pressurized liquid (15) in the inlet pipe (11).

The relief valve (3), set at a pressure above the maximum pressure expected to occur downstream of the outlet pipe (13), contributes to assure that pressure peaks in the pressurized liquid (15) at the inlet of the pressure stabilizer (14) will not propagate to the outlet of the pressure stabilizer (14), thus stabilizing the pressure in the outlet pipe (13).

The liquid that is drained through the return pipe (12) can be reused by collecting it into a container (23) and can eventually be injected again into the inlet pipe (11).

The pressure reducing valve (2) and the relief valve (3) can be set together to ensure that, during the use of the pressurized liquid (15), there is no pressure fluctuation in the constant pressure chamber (10) and in the liquid with a set pressure (21), which is possible to monitor using the pressure measuring equipment.

The ventilation tube (22), installed in the top of the constant pressure chamber (10), ensures the expulsion of air that may eventually accumulate inside the constant pressure chamber (10) of the pressure stabilizer (14).

FIG. 2 shows an air relief valve (7), which according to the embodiment of the present invention can be connected to the ventilation tube (22), shown in FIG. 1. The air relief valve (7) can be of any type of relief valve used in hydraulic systems.

The bottom drain pipe (8), installed at the bottom of the constant pressure chamber (10), and operated through the bottom drainage shut-off valve (9), contributes to the removal of particles that, despite the existence of the filter (1), may eventually accumulate in the constant pressure chamber (10) of the pressure stabilizer (14), in addition to allowing the complete drainage of the constant pressure chamber (10) of the pressure stabilizer (14).

The liquid that is drained through the bottom drain pipe (8) can be eventually reused by collecting it into a container (23), and then injected again into the inlet pipe (11).

The outlet shut-off valve (4) allows to control the flow of the liquid with a set pressure (21) downstream of the constant pressure chamber (10) of the pressure stabilizer (14), thus setting the outflow accordingly to the intended uses.

The check valve (5) prevents the inversion of the flow direction, protecting the pressure stabilizer (14) in the event of a sudden and high increase in pressure downstream of it.

Using illustrations, the results of the application of a pressure stabilizer according to the present invention are shown below. The pressure of a pressurized liquid (15) in a reservoir is about 49 meters of water column (mwc), equivalent to 481 kPa. It is desired that the pressure of the liquid with the set pressure (21) remains at about 9 mwc (88 kPa), setting the pressure reducing valve (2) to 10 mwc (98 kPa) and the relief valve (3) to 9 mwc (88 kPa).

After filling the constant pressure chamber (10), and keeping the outlet shut-off valve (4) closed, the pressure of the liquid with set pressure (21) is about 9 mwc (88 kPa).

After opening the outlet shut-off valve (4), the pressure of the pressurized liquid (15) is about 44 mwc (431 kPa) and the pressure of the liquid with a set pressure (21) is about 9 mwc (88 kPa), as desired.

Surprisingly for a person skilled in the art, it is possible to observe a decrease of the pressure fluctuation inside the constant pressure chamber (10), when compared to the pressure fluctuation of the pressurized liquid (15), of about 3 times, considering the respective standard deviations.

As used in this description, the expressions “about” and “approximately” refer to a range of values of plus or minus 10% of the specified number.

As used in this description, the expression “substantially” means that the actual value is within the range of about 10% of the desired value, variable or related limit, particularly within about 5% of the desired value, variable or related limit or especially within about 1% of the desired value, variable or related limit.

The subject-matter described above is provided as an illustration of the present invention and should not be construed to limit it. The terminology used for describing specific embodiments, in accordance with the present invention, should not be interpreted to limit the invention. As used in the description, defined and indefinite articles, in their singular form, are intended for interpretation to also include plural forms, unless the context of the description explicitly indicates otherwise. It will be understood that the terms “understand” and “include”, when used in this description, specify the presence of characteristics, elements, components, steps and related operations, but do not exclude the possibility that other characteristics, elements, components, steps and operations are also included.

All changes, so long as they do not modify the essential characteristics of the claims that follow, must be considered within the scope of protection of the present invention.

### REFERENCE SIGNS LIST

A filter (1);
A pressure reducing valve (2);
A relief valve (3);
An outlet shut-off valve (4);
A check valve (5);
A socket for fixing a pressure gauge (6);
An air relief valve (7);
A bottom drain pipe (8);
A bottom drainage shut-off valve (9);
A constant pressure chamber (10);
An inlet pipe (11);
A return pipe (12);
An outlet pipe (13);
A pressure stabilizer (14);
A pressurized liquid (15);
A downstream fitting socket (16);
An upstream fitting socket (17);
A return fitting socket (18);
An upper fitting socket (19);
A lower fitting socket (20);
Liquid with a set pressure (21);
A ventilation tube (22); and
A container (23).

1. A pressure stabilizer (14) for liquids comprising:
a constant pressure chamber (10);
an outlet pipe (13) which is attached to the constant pressure chamber (10) by means of a downstream fitting socket (16), in which an outlet shut-off valve (4) is connected to the outlet pipe (13);
an inlet pipe (11) which is attached to the constant pressure chamber (10) by means of an upstream fitting socket (17), wherein a pressure reducing valve (2) is connected to the inlet pipe (11); and
a return pipe (12) which is attached to the constant pressure chamber (10) by means of a return fitting socket (18), wherein a relief valve (3) is connected to the return pipe (12).

2. The pressure stabilizer of claim 1, wherein the outlet pipe (13) has a socket for fixing a pressure gauge (6).

3. The pressure stabilizer of claim 2, wherein a pressure measuring device is connected to the socket for fixing a pressure gauge (6).

4. The pressure stabilizer of claim 1, wherein a check valve (5) is connected to the outlet pipe (13).

5. The pressure stabilizer of claim 1, wherein at least one filter (1) is connected to the inlet pipe (11), in an upstream position in relation to the pressure reducing valve (2).

6. The pressure stabilizer of claim 1 herein a bottom drain pipe (8) is fixed to the constant pressure chamber (10) by means of a lower fitting socket (20), where a bottom drainage shut-off valve (9) is connected to the bottom drain pipe (8).

7. The pressure stabilizer of claim 1 whereina ventilation tube (22) is attached to the constant pressure chamber (10) by means of an upper fitting socket (19).

8. The pressure stabilizer of claim 7 wherein an air relief valve (7) is connected to the ventilation pipe (22).

9. The pressure stabilizer of claim 1 wherein the constant pressure chamber (10);
the inlet pipe (11);
the return pipe (12); and
the outlet pipe (13) are comprised of a rigid material.

10. A pressure stabilization process for liquids, wherein the liquid pressure stabilizer (14) is used, as defined in claim 1, and in that it has the following steps:
closing the outlet shut-off valve (4);
intake of a pressurized liquid (15) through the inlet pipe (11) with a reduction in the pressure of the liquid through the operation of the pressure reducing valve (2);
filling the constant pressure chamber (10) with liquid until the relief valve (3) starts operating;
opening the outlet shut-off valve (4);
setting the pressure in the constant pressure chamber (10) using the pressure reducing valve (2), connected to the inlet pipe (11), and the relief valve (3), connected to the return pipe (12); and
outlet of the liquid with a set pressure (21) through the outlet pipe (13).

11. The pressure stabilization process of claim 10 wherein the pressure of the liquid with a set pressure (21) downstream of the constant pressure chamber (10) is set by the outlet shut-off valve (4), connected to the outlet pipe (13).

12. The pressure stabilization process for liquids of claim 10 wherein the outlet pressure of the liquid with a set pressure (21) is monitored by means of a pressure measurement equipment, connected to the outlet pipe (13).

13. The pressure stabilization process of claim 10 wherein the backflow of the liquid with a set pressure (21) is cut by means of the check valve (5), connected to the outlet pipe (13).

14. The pressure stabilization process of claim 10 wherein the pressurized liquid (15) is filtered through at least one filter (1), which is connected to the inlet pipe (11), upstream of the pressure reducing valve (2).

15. The pressure stabilization process of claim 10 wherein the particles that accumulate in the constant pressure chamber (10) are purged by means of the bottom drainage shut-off valve (9), which is connected to the bottom drain pipe (8).

16. The pressure stabilization process of claim 10 wherein the liquid which is drained through the return pipe (12) can be eventually reused by collecting it into a container (23) or be injected again into the inlet pipe (11).

17. The pressure stabilization process of claim 10 wherein the liquid that is drained through the bottom drain pipe (8) can be eventually reused by collecting it into a container (23) or be injected again into the inlet pipe (11).

18. The pressure stabilization process of claim 10 wherein the air accumulated inside the constant pressure chamber (10) is purged through the ventilation tube (22).
